(19) United States
(12) Patent Application Publication
(10) Pub. No.: US 2023/0274348 A1
(43) Pub. Date: Aug. 31, 2023

(54) ON-DEMAND FUNDING SYSTEM

(71) Applicant: Hint, Inc., Pleasanton, CA (US)

(72) Inventors: Muthanna Nischal Ammatanda, Fremont, CA (US); Akhil Kumar Koo, Fremont, CA (US); Rhys Andersson Lee Chiu, Daly City, CA (US); Abraham Benjamin de Waal, San Jose, CA (US)

(21) Appl. No.: 17/683,262

(22) Filed: Feb. 28, 2022

(51) Int. Cl. G06Q 40/02

(52) U.S. Cl. CPC G06Q 40/02

(57) ABSTRACT

Systems and methods herein describe an on-demand funding system. The on-demand funding system receives order data, identifies that the order is a deferred funding type, submits a first request to the funding source to transfer the order amount from the funding source to an intermediate bank account, determines a first fee amount associated with the order data, generates a modified order amount based on deducting the first fee amount from the order amount, submits a second request to transfer the first fee amount from the intermediate bank account to a point-of-sale system bank account, and submits a third request to transfer the modified order amount from the intermediate bank account to a deferred bank account.

### TECHNICAL FIELD

Embodiments herein generally relate to an instruction-based funding system. More specifically, but not by way of limitation, embodiments herein describe an on-demand funding system.

### BACKGROUND

Managing transactions between an entity and clients can be a cumbersome task. When entities offer a wide array of goods and services, efficiently managing and documenting each transaction can prove to be complicated

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example point-of-sale system for conducting transactions over a network.

FIG. 2 is a flow diagram describing an example process for determining if a payment is an immediate payment or a deferred payment, according to example embodiments.

FIG. 3A is a flow diagram illustrating an example process for collecting payment from a user by an on-demand funding server, according to example embodiments.

FIG. 3B is a flow diagram illustrating an example process for fully redeeming purchased goods or services by an on-demand funding server, according to example embodiments.

FIG. 3C is a flow diagram illustrating an example process for processing a refund for previously redeemed goods or services by an on-demand funding server, according to example embodiments.

FIG. 4 is a flow diagram illustrating an example method for processing a transaction by an on-demand funding server, according to example embodiments.

FIG. 5 is a block diagram illustrating a software architecture, which can be installed on any one or more of the devices described herein.

FIG. 6 is a diagrammatic representation of an example machine within which instructions for causing a machine to perform any one or more of the methodologies discussed herein may be executed.

### DETAILED DESCRIPTION

Various embodiments described herein provide for an on-demand funding system that processes an order for a good or service. The order may be received from a practice entity that is offering the ordered good or service. The on-demand funding system determines if the order qualifies as a deferred funding type. An order qualifies for deferred funding based on the type of payment used to place the order and whether the order is a one-time purchase, or a subscription offer purchase. After the on-demand funding system determines that the order qualifies as a deferred funding type, the system initiate a transfer of funds from the payment source to an intermediate bank account. The system calculates a transaction fee associated with the order and initiates a transfer of the transaction fee amount from the intermediate bank account to a point-of-sale bank account. The remaining funds associated with the order are then transferred from the intermediate bank account to a deferred bank account.

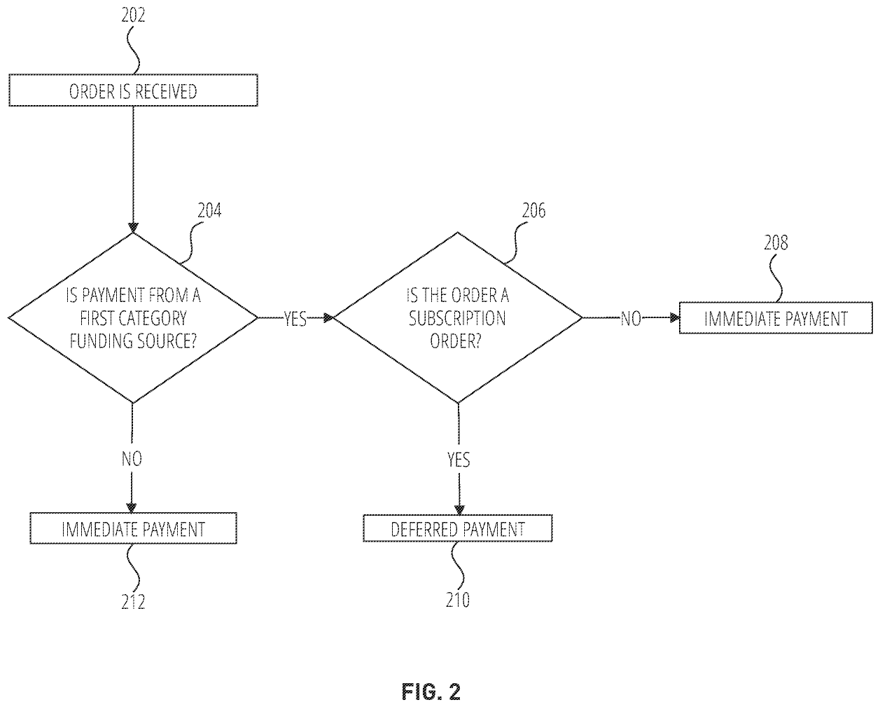

The on-demand funding system holds the funds in the deferred bank account until the funds have been redeemed (e.g., physically received or obtained) by a user or until a refund is requested. The disclosed on-demand funding system provides technical advantages over previous systems by storing transaction data in separate databases thereby improving management of the transaction data. Specifically, the on-demand funding system selectively stores incoming and outgoing transaction data in pre-configured databases using data structures (e.g., database records) that allow for a more efficient tracking of transaction data. Further details of the on-demand funding system are described in FIGS. 2-4 below.

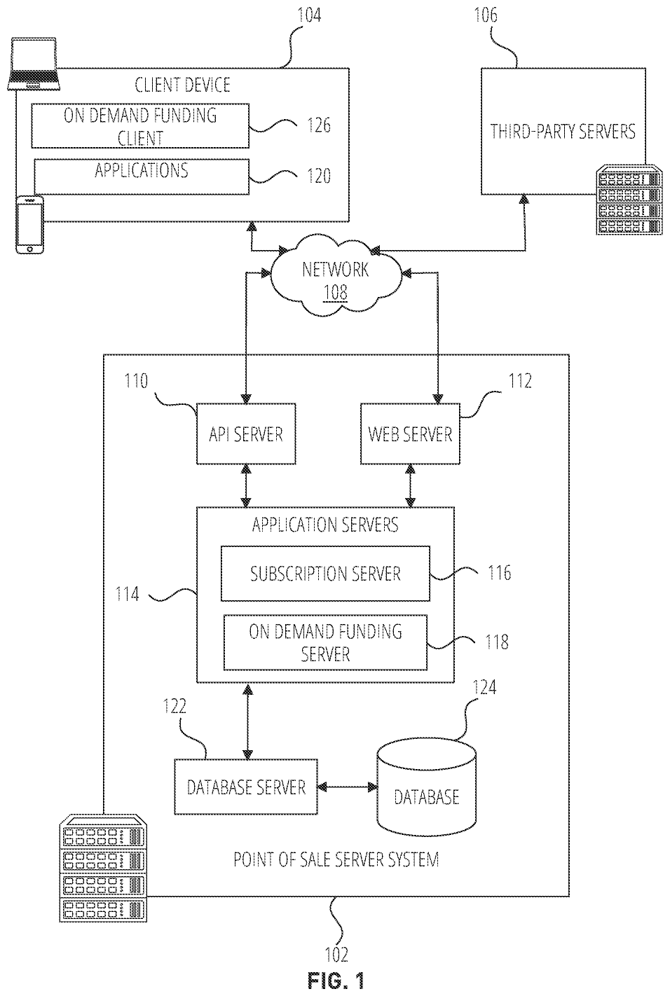

FIG. 1 is a block diagram showing an example point-of-sale system for conducting transactions over a network. The point-of-sale system includes multiple instances of a client device 104, each of which hosts a number of applications, including an on-demand funding client 126 and other applications 120. Each on-demand funding client 126 is communicatively coupled to other instances of the on-demand funding client 126 (e.g., hosted on respective other client devices 104), a point-of-sale server system 102 and third-party servers 106 via a network 108 (e.g., the Internet). The applications 120 can also communicate with other locally-hosted applications 120 using Applications Program Interfaces (APIs).

The point-of-sale server system 102 provides server-side functionality via the network 108 to an on-demand funding client 126. While certain functions of the point-of-sale system are described herein as being performed by either an on-demand funding client 126 or by the point-of-sale server system 102, the location of certain functionality either within the on-demand funding client 126 or the point-of-sale server system 102 may be a design choice. For example, it may be technically preferable to initially deploy certain technology and functionality within the point-of-sale server system 102 but to later migrate this technology and functionality to the on-demand funding client 126 where a client device 104 has sufficient processing capacity.

The point-of-sale server system 102 supports various services and operations that are provided to the on-demand funding client 126. Such operations include transmitting data to, receiving data from, and processing data generated by the on-demand funding client 126. This data may include transaction data, user data, subscription data and provider data, as examples. Data exchanges within the point-of-sale server system 102 are invoked and controlled through functions available via user interfaces (UIs) of the on-demand funding client 126.

Turning now specifically to the point-of-sale server system 102, an Application Program Interface (API) server 110 is coupled to, and provides a programmatic interface to, application servers 114. The application servers 114 are communicatively coupled to a database server 122, which facilitates access to a database 124 that stores data associated with the transactions processed by the application servers 114. Similarly, a web server 112 is coupled to the application servers 114 and provides web-based interfaces to the application servers 114. To this end, the web server 112 processes incoming network requests over the Hypertext Transfer Protocol (HTTP) and several other related protocols.

The API server 110 receives and transmits transaction data (e.g., commands and transaction data) between the client device 104 and the application servers 114. Specifically, the API server 110 provides a set of interfaces (e.g., routines and protocols) that can be called or queried by the on-demand funding client 126 in order to invoke functionality of the application servers 114. The API server 110 exposes various functions supported by the application servers 114, including account registration, subscription creations and management, the processing of transactions, via the application servers 114, from a particular on-demand funding client 126 to another on-demand funding client 126.

The application servers 114 host a number of server applications and subsystems, including for example a subscription server 116, and an on-demand funding server 118. The subscription server 116 implements functionalities for creating and managing subscriptions between multiple client devices 104.

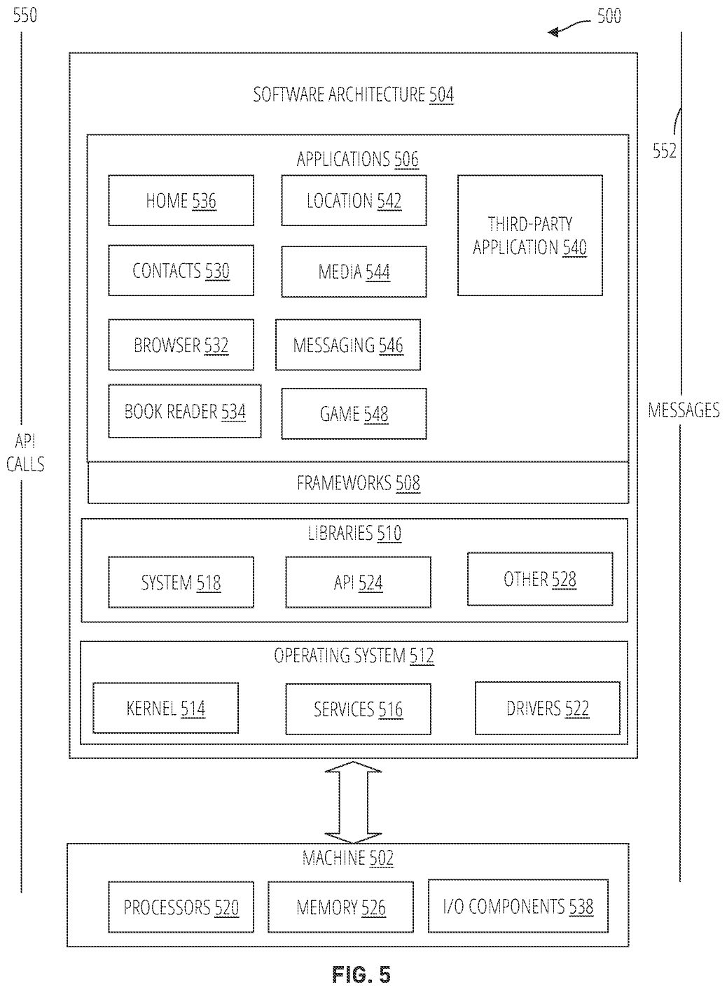

The on-demand funding server 118 provides functionalities for deferring the transfer of funds associated with a subscription or other order item based on aspects of the transaction. Further details regarding the on-demand funding server 118 are provided below in connection with FIG. 5.

FIG. 2 is a flow diagram describing an example process for determining if a payment is an immediate payment or a deferred payment, according to example embodiments. In one example, the processor in an on-demand funding server 118, the processor in the client device 104, the processor in the point-of-sale server system 102 or any combination thereof, can perform the steps shows in FIG. 2.

At operation 202, the on-demand funding server 118 receives an order. The order may be for a one-time purchase or a subscription offering and the order may further be associated with an order amount. At operation 204, the on-demand funding server 118 determines if the payment associated the order belongs to a first category funding source. A funding source includes a payment instrument and optionally, an associated bank account. The on-demand funding server 118 may accept payments from multiple categories of funding sources. A first category funding source includes physical credit cards, gift cards, debit card, cash and check payments. A second category funding source include payments from a virtual wallet or any other virtual representation of a physical wallet.

If the payment is not from a first category funding source (e.g., payment is from a second category funding source), then at operation 212, the on-demand funding server 118 flags the payment as an immediate payment.

If the payment is from a first category funding source, the on-demand funding server 118 then determines at block 206, whether the payment is associated with a one-time purchase or a subscription offer. If the payment is one-time purchase, the on-demand funding server 118 flags the payment as an immediate payment at block 208. If the payment is associated with a subscription offer, the on-demand funding server 118 flags the payment as a deferred payment at block 210.

The on-demand funding server 118 processes immediate payments by immediately transferring a first portion of the order amount to a point-of-sale account and a second portion of the order amount to a practice account. The first portion may be a fee amount and the second portion may be a revenue amount. The on-demand funding server 118 processes deferred payments by transferring the first portion of the order amount to a point-of-sale account and a second portion of the order amount to an intermediate account.

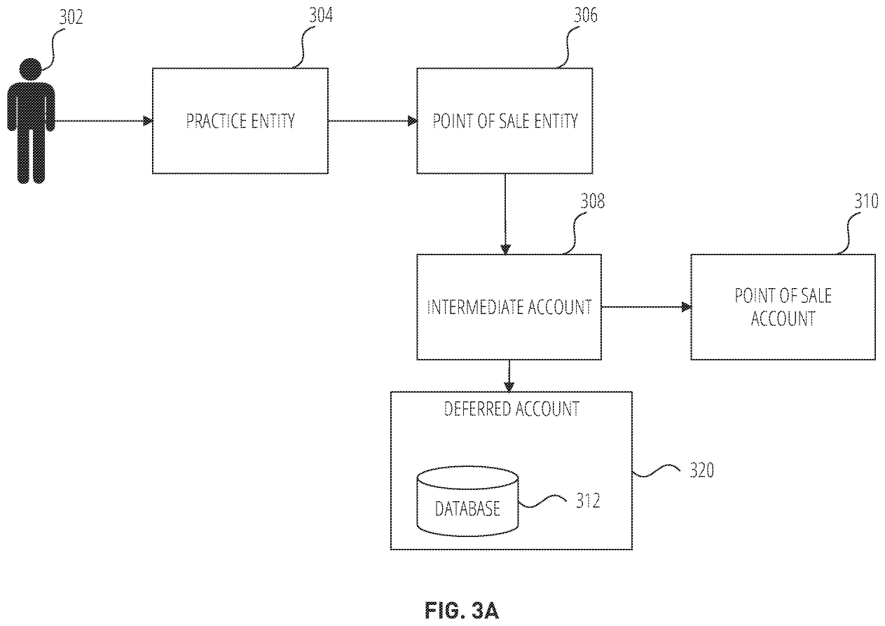

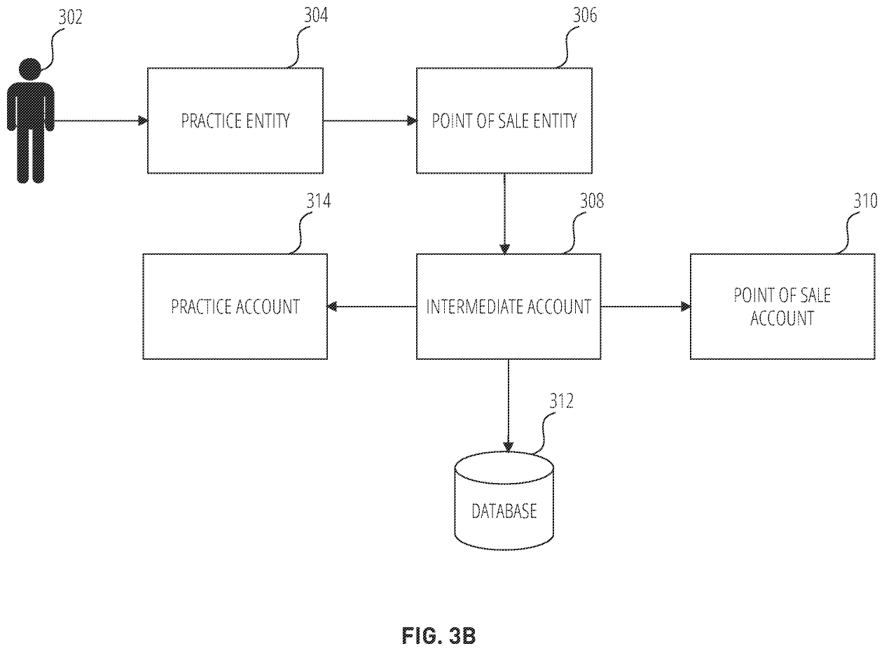

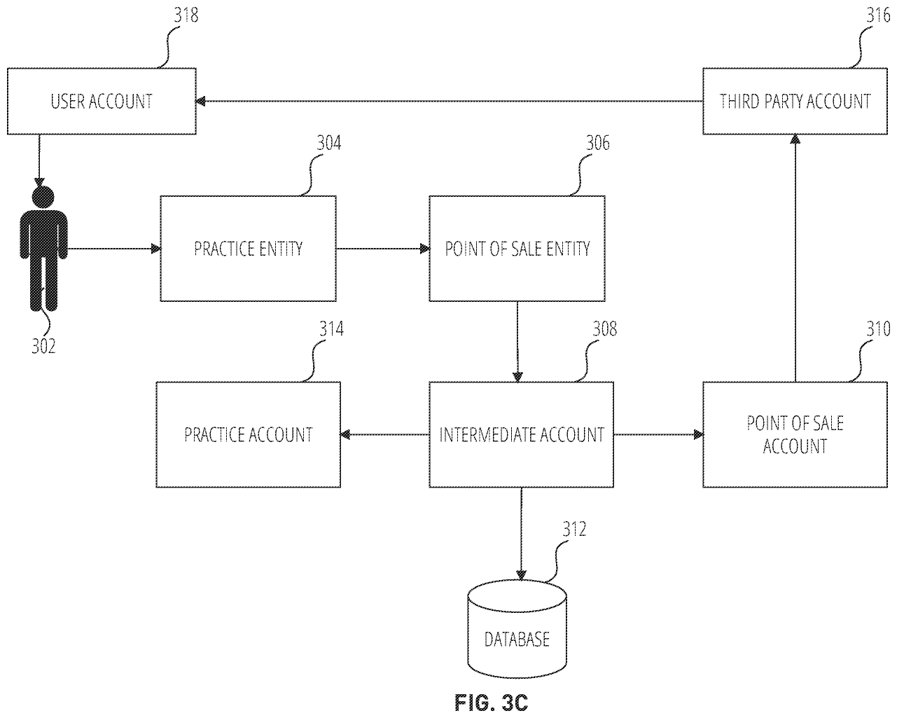

FIGS. 3A, 3B, and 3C illustrate a process for depositing funds as performed by the on-demand funding server 118, according to example embodiments. In one example, the processor in an on-demand funding server 118, the processor in the client device 104, the processor in the point-of-sale server system 102 or any combination thereof, can perform the steps shows in FIGS. 3A-3C.

FIG. 3A is a process for collecting payment from a user 302. A user 302 may decide to purchase a subscription offer from a practice entity 304. The subscription offer may be, for example, a bundle of cosmetic services or goods. The payment may be for goods or services that are to be redeemed at a later date. The practice entity 304 may be a healthcare provider or other licensed service provider. A user 302 directly pays the practice entity 304 a predetermined order amount using at least one funding source. The practice entity 304 is communicatively coupled with a point-of-sale entity 306. The point-of-sale entity 306 may facilitate various subscription offerings and purchases between a user 302 and a practice entity 304. The point-of-sale entity 306 may provide one or more applications 120 to the practice entity 304, including the on-demand funding client 126, which may be used by the practice entity 304 to facilitate transactions between the practice entity 304 and user 302.

After the user 302 purchases a subscription offer from the practice entity 304, the point-of-sale entity 306 retrieves the funds from the funding source and transfers the entire order amount associated with the subscription offer in the intermediate account 308. The on-demand funding server 118 calculates a transaction fee associated with the point-of-sale entity's 306 services and transfers the transaction fee amount to the point-of-sale account 310. The on-demand funding server 118 instructs the intermediate account 308 to transfer the remaining funds into the deferred account 320. The on-demand funding server 118 further adds an entry in a database 312 that reflects the transaction and the amount of funds that is being held in the deferred account 320. The database 312 serves a virtual ledger of transactions associated with the deferred account 320. The intermediate account 308, point-of-sale account 310, and deferred account 320 may all be bank accounts. In some examples, the intermediate account 308, point-of-sale account 310, and deferred account 320 may be virtual accounts. For example, a virtual account may be represented as one or more databases associated with the point-of-sale system.

For example, a user 302 may pay the practice entity 304 $100 for a bundle of services. The point-of-sale entity 306 transfers the entire $100 to an intermediate account 308. The intermediate account 308 may be a bank account. The on-demand funding server 118 further calculates a fee (e.g., a transaction fee). The fee may be a percentage of the order amount. In some examples, the fee is a two percent fee. The on-demand funding server 118 initiates a transfer of 2% of $100 ($2) from the intermediate account 308 to the point-of-sale account 310, and transfers the remaining $98 from the intermediate account 308 to the deferred account 320.

FIG. 3B is a process for fully redeeming goods or services that were purchased by the user 302. The user 302 may arrive at the practice entity 304 to redeem the entire value of their purchase. When the purchase is redeemed, the on-demand funding server 118, transfers the funds that were previously held in the deferred account 320 to the practice account 314 (e.g., a bank account associated with the practice). Using the example numbers above, the on-demand funding server 118 initiates a transfer $98 from the deterred account 320 to the practice account 314 once the goods or services have been redeemed. The on-demand funding server 118 updates the database 312 based on the transfer of funds in real time or near real-time.

FIG. 3C is a process for refunding a user for goods or services that were purchased by the user 302. The user 302 may arrive at the practice entity 304 to request a refund for the entire value of their purchase. When the refund is requested, the on-demand funding server 118 verifies that the purchase has not been redeemed. The on-demand funding server 118 requests the third party account 316 to remove funds from the point-of-sale account 310 and transfer the funds to the user account 318. Using the example numbers above, the on-demand funding server 118 instructs the third party account 316 to remove $100 from the point-of-sale account 310.

The on-demand funding server 118 further instructs the point-of-sale account 310 to withdraw funds from the intermediate account 308 that correlate to the revenue of the practice entity 304. Thus, using the example numbers above, the on-demand funding server 118 instructs the point-of-sale account 310 to withdraw $2 from the intermediate account 308. The remaining $98 that are held in the deferred account 320 are then transferred back to the point-of-sale account 310.

In some examples, during the process flow described in FIG. 3A, the on-demand funding server 118 initiates a transfer of a portion of the calculated fee from the point-of-sale account 310 to the third party account 316. In some examples, a user 302 may wish to redeem only a portion of their purchase or initiate a refund for a portion of the purchase.

Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

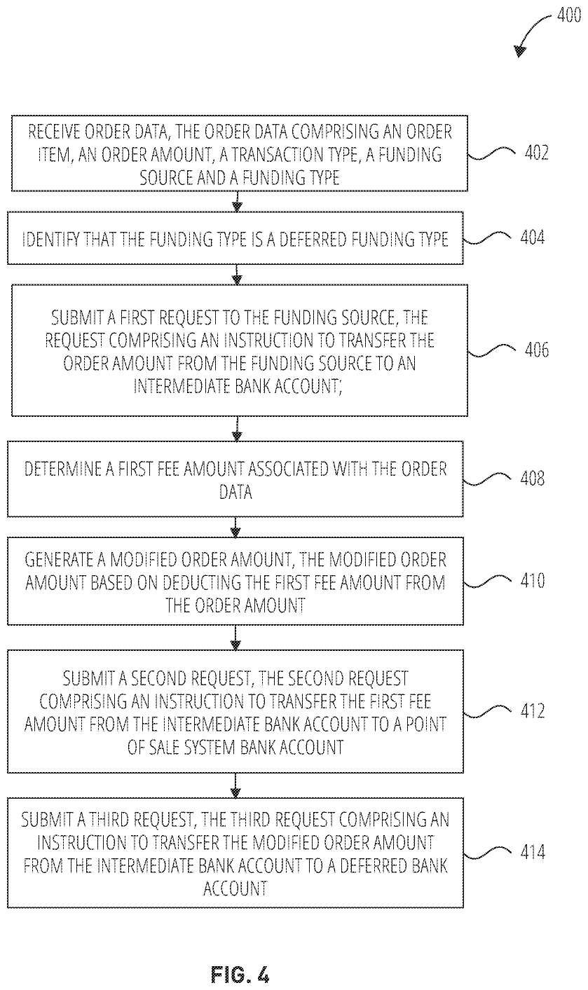

FIG. 4 is a method 400 for processing a transaction by an on-demand funding server 118, according to example embodiments. In one example, the processor in an on-demand funding server 118 the processor in the client device 104, the processor in the point-of-sale server system 102 or any combination thereof, can perform the operations in the method 400. In some examples, the operations of method 400 may be performed as a series of API calls.

At operation 402, the on-demand funding server 118 receives order data, the order data comprising an order item, an order amount, a transaction type, a funding source, and a funding type. The order data may be received from a client device 104 associated with the practice entity 304. The order item may be a cosmetic service or good. The order amount is a cost associated with the order item. The transaction type indicates whether the order item is a one-time purchase or a subscription offer. The funding source includes a payment instrument, and optionally an associated bank account. The funding type indicates whether the order item qualifies for immediate payment or deferred payment. Further details on the distinction between immediate payment and deferred payments are discussed above in connection with FIG. 2.

At operation 404, the on-demand funding server 118 determines that the funding type is a deferred funding type. The determination is based whether the transaction qualifies to be flagged as a deferred funding type. Further details are described above in connection with FIG. 2.

At operation 406, the on-demand funding server 118 sends a first API request to the funding source. The first API request comprises an instruction to transfer the order amount from the funding source to an intermediate bank account. The request may be submitted using one or more API calls via the API server 110. The intermediate bank account may be the intermediate account 308. The order amount may be transferred from the user account 318 to the intermediate account 308.

At operation 408, based on the determination and the transaction type, the on-demand funding server 118 determines a first fee amount associated with the order data. The first fee amount may be the transaction fee discussed above in connection with FIG. 3A.

At operation 410, the on-demand funding server 118 generates a modified order amount. The modified order amount based on deducting the first fee amount from the order amount.

At operation 412, the on-demand funding server 118 sends a second API request to the intermediate bank account. The request comprises an instruction to transfer the first fee amount from the intermediate bank account to the point-of-sale bank account. The point-of-sale bank account may be the point-of-sale account 310.

At operation 414, the on-demand funding server 118 sends a third API request to the intermediate bank account. The request comprises an instruction to transfer the modified amount from the intermediate bank account to a deferred bank account. The deferred bank account may be the deferred account 320. The transfer of funds associated with the deferred account 320 may be stored in a database. For example, the database may be the database 312.

In some examples, the on-demand funding server 118 receives, from a client device, an indication that the order item is fulfilled. For example, the indication may be received from a client device 104 associated with a practice entity 304 that is running the on-demand funding client 126. In response to receiving the indication, the on-demand funding server 118 submits a fourth request, the fourth request comprising an instruction to transfer the modified order amount from the deferred bank account to a practice bank account. The practice bank account may be the practice account 314.

In some examples, the on-demand funding server 118 adds the funding source as a wallet item to a virtual wallet application associated with the user 302 (and a client device associated with the user 302). The user 302 may use the virtual wallet for payment of the cosmetic service or good. The user 302 may use their credit card to periodically deposit funds from their credit card (or any other payment instrument) to a wallet item within the virtual wallet. A user 302 may have multiple wallet items within their virtual wallet. Some wallet items may be designated for a specific use, and some may not have any specific designation.

FIG. 5 is a block diagram 500 illustrating a software architecture 504, which can be installed on any one or more of the devices described herein. The software architecture 504 is supported by hardware such as a machine 502 that includes processors 520, memory 526, and I/O components 538. In this example, the software architecture 504 can be conceptualized as a stack of layers, where each layer provides a particular functionality. The software architecture 504 includes layers such as an operating system 512, libraries 510, frameworks 508, and applications 506. Operationally, the applications 506 invoke API calls 550 through the software stack and receive messages 552 in response to the API calls 550.

The operating system 512 manages hardware resources and provides common services. The operating system 512 includes, for example, a kernel 514, services 516, and drivers 522. The kernel 514 acts as an abstraction layer between the hardware and the other software layers. For example, the kernel 514 provides memory management, processor management (e.g., scheduling), component management, networking, and security settings, among other functionality. The services 516 can provide other common services for the other software layers. The drivers 522 are responsible for controlling or interfacing with the underlying hardware. For instance, the drivers 522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 510 provide a low-level common infrastructure used by the applications 506. The libraries 510 can include system libraries 518 (e.g., C standard library) that provide functions such as memory allocation functions, string manipulation functions, mathematic functions, and the like. In addition, the libraries 510 can include API libraries 524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 510 can also include a wide variety of other libraries 528 to provide many other APIs to the applications 506.

The frameworks 508 provide a high-level common infrastructure that is used by the applications 506. For example, the frameworks 508 provide various graphical user interface (GUI) functions, high-level resource management, and high-level location services. The frameworks 508 can provide a broad spectrum of other APIs that can be used by the applications 506, some of which may be specific to a particular operating system or platform.

In an example embodiment, the applications 506 may include a home application 536, a contacts application 530, a browser application 532, a book reader application 534, a location application 542, a media application 544, a messaging application 546, a game application 548, and a broad assortment of other applications such as a third-party application 540. The applications 506 are programs that execute functions defined in the programs. Various programming languages can be employed to create one or more of the applications 506, structured in a variety of manners, such as object-oriented programming languages (e.g., Objective-C, Java, or C++) or procedural programming languages (e.g., C or assembly language). In a specific example, the third-party application 540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 540 can invoke the API calls 550 provided by the operating system 512 to facilitate functionality described herein.

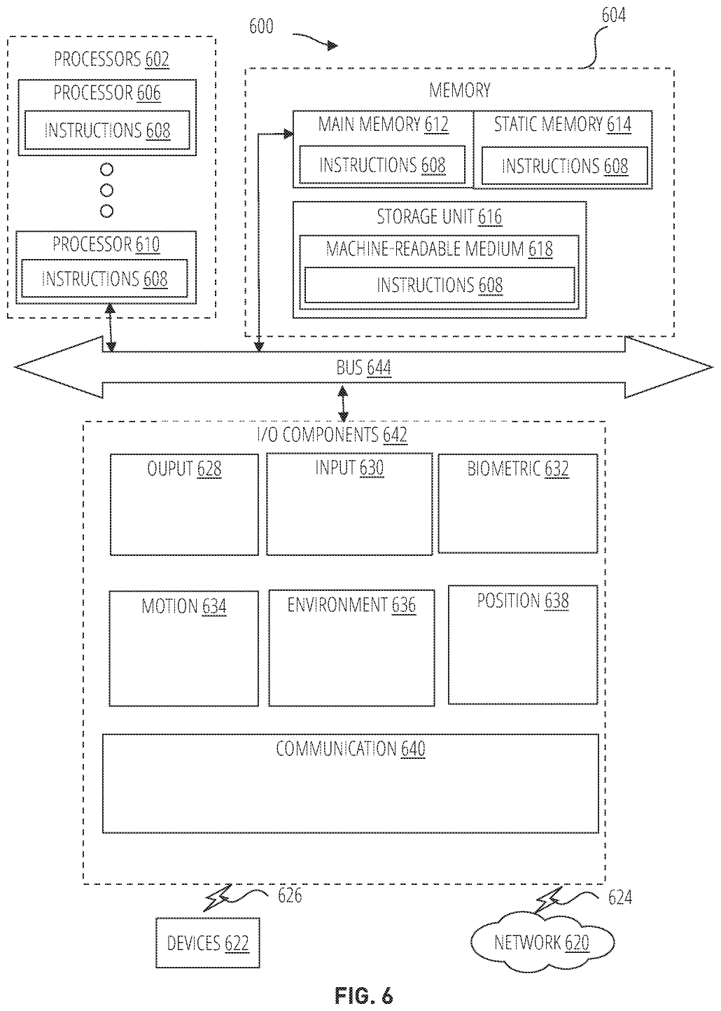

FIG. 6 is a diagrammatic representation of the machine 600 within which instructions 608 (e.g., software, a program, an application, an apples, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and I/O components 642, which may be configured to communicate with each other via a bus 644. In an example embodiment, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 612, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown in FIG. 6. In various example embodiments, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614 and/or memory of the processors 602) and/or storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed embodiments.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 624 (e.g., a peer-to-peer coupling) to the devices 622.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving order data for a requested order, the order data comprising an order item, an order amount, a transaction type, a funding source and a funding type;
determining that the funding type is a deferred funding type;
sending a first application programming interface (API) request to an external computer transfer system associated with the funding source, the first request comprising an instruction to transfer the order amount from the funding source to an intermediate bank account;
based on the determination and the transaction type; determining a first fee amount associated with the requested order;
generating a modified order amount by deducting the first fee amount from the order amount;
sending a second API request, the second request comprising an instruction to transfer the first fee amount from the intermediate bank account to a point-of-sale system bank account; and
sending a third API request, the third request comprising an instruction to transfer the modified order amount from the intermediate bank account to a deferred bank account.

2. The method of claim 1, further comprising:
storing the order data in a database.

3. The method of claim 2, wherein the database comprises a virtual ledger of a plurality of order data.

4. The method of claim 1, wherein the transaction type comprises at least one of a subscription offering or a one-time purchase.

5. The method of claim 1, wherein the funding source comprises a payment instrument.

6. The method of claim 1, wherein the funding type is a deferred funding type or an immediate funding type.

7. The method of claim 1, wherein determining the funding type further comprises:
determining that the funding type is a first category funding type; and
in response to determining that the funding type is a first category funding type, determining that the funding type is the deferred funding type.

8. The method of claim 1, further comprising:
adding the funding source to a virtual wallet application, wherein the virtual wallet application is associated with a user of a user client device.

9. The method of claim 1, further comprising:
receiving, from a client device, an indication that the order item is fulfilled; and
sending a fourth APT request, the fourth APT request comprising an instruction to transfer the modified order amount from the deferred bank account to a practice bank account.

10. A system comprising:
a processor; and
a memory storing instructions that, when executed by the processor, configure the system to perform operations comprising:
receiving order data for a requested order, the order data comprising an order item, an order amount, a transaction type, a funding source and a funding type;
determining that the funding type is a deferred funding type;
sending a first application programming interface (API) request to an external computer transfer system associated with the funding source, the first request comprising an instruction to transfer the order amount from the funding source to an intermediate bank account;
based on the determination and the transaction type, determining a first fee amount associated with the requested order;
generating a modified order amount by deducting the first fee amount from the order amount;
sending a second API request, the second request comprising an instruction to transfer the first fee amount from the intermediate bank account to a point-of-sale system bank account; and
sending a third API request, the third request comprising an instruction to transfer the modified order amount from the intermediate bank account to a deferred bank account.

11. The system of claim 10, wherein the operations further comprise:
storing the order data in a database.

12. The system of claim 11, wherein the database comprises a virtual ledger of a plurality of order data.

13. The system of claim 10, wherein the transaction type comprises at least one of a subscription offering or a one-time purchase.

14. The system of claim 10, wherein the funding source comprises a payment instrument.

15. The system of claim 10, wherein the funding type is a deferred funding type or an immediate funding type.

16. The system of claim 10, wherein determining the funding type further comprises:
determining that the funding type is a first category funding type; and
in response to determining that the funding type is a first category funding type, determining that the funding type is the deferred funding type.

17. The system of claim 10, wherein the operations further comprise:
adding the funding source to a virtual wallet application, wherein the virtual wallet application is associated with a user of a user client device.

18. The system of claim 10, wherein the operations further comprise:
receiving, from a client device, an indication that the order item is fulfilled; and
sending a fourth API request, the fourth API request comprising an instruction to transfer the modified order amount from the deferred bank account to a practice bank account.

19. A non-transitory computer-readable storage medium, the computer-readable storage medium including instructions that when executed by a computer, cause the computer to perform operations comprising:
receiving order data for a requested order, the order data comprising an order item, an order amount, a transaction type, a funding source and a funding type;
determining that the funding type is a deferred funding type;
sending a first application programming interface (API) request to an external computer transfer system associated with the funding source, the first request comprising an instruction to transfer the order amount from the funding source to an intermediate bank account;
based on the determination and the transaction type, determining a first fee amount associated with the requested order;
generating a modified order amount by deducting the first fee amount from the order amount;
sending a second API request, the second request comprising an instruction to transfer the first fee amount from the intermediate bank account to a point-of-sale system bank account; and
sending a third API request, the third request comprising an instruction to transfer the modified order amount from the intermediate bank account to a deferred bank account.

20. The computer-readable storage medium of claim 19, wherein the operations further comprise:
storing the order data in a database.
